(19) United States
(12) Patent Application Publication
(10) Pub. No.: US 2003/0078058 A1
(43) Pub. Date: Apr. 24, 2003

(54) Method for transmission of secure messages in a telecommunications network

(76) Inventors: Harri Vatanen, Englefield Green (GB); Jukka Liukkonen, Helsinki (FI); Matti Hiltunen, Helsinki (FI)

Correspondence Address: COHEN, PONTANI, LIEBERMAN & PAVANE, Suite 1210, 551 Fifth Avenue, New York, NY, 10176, US

(21) Appl. No.: 09/931,338

(22) Filed: Aug. 16, 2001

(30) Foreign Application Priority Data
Feb. 16, 1999 (FI) 990323
Feb. 16, 2000 PCT/FI00/00116

(51) Int. Cl. H04M 1/66; H04M 1/68; H04M 3/16; H04Q 7/20

(52) U.S. Cl. 455/466; 455/411

(57) ABSTRACT

The inventive method enables the signing and/or encrypting of a message to be transmitted from a sending party to a receiving party over a telecommunication network with the ability to ascertain from the message the identity of the sender and the integrity of the message contents. The message for transmission is divided into at least a header section, to which a sender identification is added, and a data section, to which a check element generated from the contents of the message is appended. The data section of the message is then signed and/or encrypted so as to permit the receiver to reliably identify the identity of the sender. Use of the check element additionally permits confirmation that the message contents have not been unintendedly modified or corrupted and that the message has been decrypted using the correct decryption key.

### BACKGROUND OF THE INVENTION

1. Field of the Invention

The present invention relates to telecommunication systems and, in particular, to a method whereby a message to be transmitted to a receiver is signed and/or encrypted such that the identity of the sender and correctness or integrity of the message can be readily verified.

2. Description of Related Art

The transmission of information from one location to another in the form of a bit stream is relatively straightforward and is relatively easy to implement. More difficult, however, is subsequent verification that the information that has been or is being transmitted remains unchanged during transmission—i.e. the correctness or integrity of the transmitted content. Likewise, in an increasing number of data transmission applications and implementations, the sender additionally desires to insure that the information transmitted can be received in usable form only by the particular party for whom the information was originally intended. Encryption is commonly utilized to achieve this end, i.e. to insure that the transmitted information will only be useful to the party that possesses the encryption key that allows the message to be successfully decrypted. The strength of the encryption employed is based on the expectation and fact that available computers would be incapable of readily cracking the encryption code in a finite or reasonable period of time justified by the significance of the message contents.

References in this disclosure to “messages” is primarily intended to denote and relate to so-called short messages, as for example implemented in a Short Messaging Service (SMS) in a GSM (Global System for Mobile communications) telecommunication network or system. Nevertheless, it should be understood that the term “message”, as used herein, may also refer to other types of messages commonly used or applicable or available for use in GSM or other telecommunication networks and systems.

It is known that short messages used in mobile communication systems, such as the GSM system, can be encrypted to insure that the message will not be visible in plain or unencrypted form to outsiders or unintended third parties. The short message is encrypted and a check element is generated from the message using, for example, a hash function. The check element and the encrypted message are transmitted as separate short messages to the receiver. The receiver decrypts the received message, and the check element received in the second or other message is then compared with the decrypted data section.

One significant problem with this currently-utilized system is that the aggregate of operations, comprising signature and encryption of the message and generation of the check element, must be transmitted to the receiver in two separate messages, as for example using the preferred short messages.

### OBJECTS AND SUMMARY OF THE INVENTION

It is accordingly the desideratum of the present invention to eliminate, or at least significantly alleviate, the drawbacks and deficiencies of heretofore known methods and apparatus, such by way of example as that discussed above.

It is a specific object of the invention to provide a novel method in which the encryption and/or signature of a message, and the ability to verify the identity of the sender of the message and the correctness or integrity of the transmitted message contents, are achieved in a transmission using only a single short message. Thus, the desired encrypted message, together with unequivocal verification data for both the sender and the receiver, is transmitted in a single normal message, preferably a short message in the GSM system.

The inventive method accordingly relates to the encryption and/or signature of a message, and to verification of the sender of the message and of the correctness or integrity of its contents. In accordance with a preferred implementation of the method, the message to be transmitted is divided into two or more sections, namely at least a header section and a data section. The header section contains information relating to the sender of the message, i.e. it identifies the signatory of the message. Where a public-private key encryption method is employed, the header section contains data indicating whose public key is required to decrypt the signature.

The data section will generally contain, inter alia, the text and/or other informational contents of the message to be transmitted. For use in verifying of the correctness or integrity of the message contents, a check element is generated from the contents of the data section of the message and is appended to the end of the data section. The check element may be generated using a suitable hash function. The ability to verify the message contents correctness or integrity is based on use by both the sender and receiver of the message of the same hash function. Should an attempt be made to decrypt the message using an incorrect decryption key, then the check elements generated by the sender and the receiver will differ. The check element additionally functions as a checksum, in that it will indicate whether any errors have occurred in the transmission of the message. After the check element has been appended to the data section, the message is encrypted. The encryption method used may for example be a public-private key method, which as known produces relatively strong encryption. The encryption algorithm may be the known RSA (Rivest, Samir, Adleman) algorithm or any other algorithm or method that produces sufficiently strong encryption.

The receiver of the message can determine the encryption method that has been utilized in the received message by way of an identifier included in the header section of the message. Where a public-private key method is used, the data section of the message is first signed with the sender's secret (i.e. private) signing key. When the message is thereafter decrypted by the receiver, the receiver can thereby unequivocally ascertain and confirm the identity of the sender using the sender's public key. After it has been signed, the message is encrypted by the sender, as for example using the receiver's public signing key. In this manner only the correct or intended receiver, using his or her own secret or private key, will be able to decipher the encrypted message into plain text or language to ascertain the contents of the original, unencrypted message.

In the event that the contents of the message are found to differ from that which is expected, then the receiver may request retransmission of the message. In accordance with the inventive method an acknowledgement of successful transmission of the message may also be returned to the sender of the message.

Although encryption and signing of a message are herein described and generally contemplated for use with reference to the GSM system, in which encryption and/or signature may be carried out using a mobile station, it should be understood and will be appreciated that the GSM system is only one preferred example of a communications environment in which the invention may be implemented.

### BRIEF DESCRIPTION OF THE DRAWINGS

In the drawings:

FIG. 1 is a diagrammatic flow chart of a method implemented in accordance with a currently preferred embodiment of the present invention; and

FIG. 2 diagrammatically depicts the steps for generating an identifier for inclusion in the header section of a message in accordance with the inventive method of FIG. 1.

### DETAILED DESCRIPTION OF THE CURRENTLY PREFERRED EMBODIMENTS

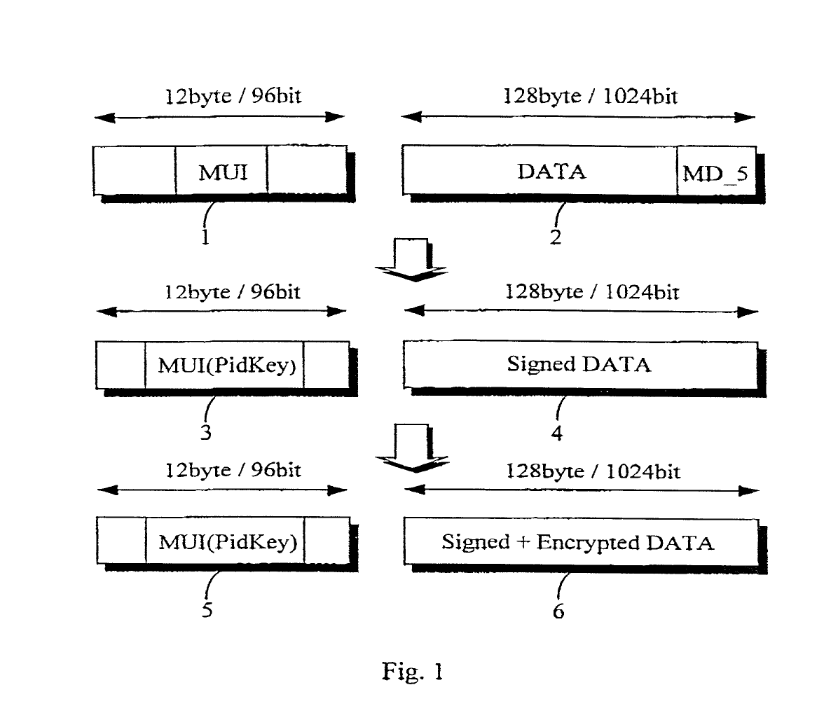

Shown in FIG. 1 is the structure of a signed and encrypted SMS message. In the embodiment of the inventive method shown and described here, a public-private key method and the RSA algorithm are used by way of illustrative example. In accordance with the invention a message intended for transmission from a sending party to a receiving party is formed or divided into at least two sections denoted the header section 1 and the data section 2. The header section 1 of the message contains a Mobile User Identification (MUI) identifier of the sender, i.e. of the signatory of the message. The length of the header section is 12 bytes which, as is well known, comprises 96 bits. An MD_{—}5 (Message Digest 5) check element, having a length of 16 bytes, is appended to the end of data section 2. The check element is generated based on the contents of the data section 2 using a hash function, which in the herein-described embodiment is the MD5 algorithm.

Next, the data section 2 is signed using the sender's private or secret signing key, thereby producing a data section 4 that has been signed by the sender. The MUI (PidKey) field in the header section 3 now contains an identification of the sender or signatory of the message. The sender identification MUI (Pidkey) is a five-byte field and identifies whose public signing key is to be used to decrypt and verify the signature. The receiver of the message may already know or have the sender's public key or may request and retrieve it from a Trusted Third Party (TTP).

In the next step, the header section 3 remains unchanged. The data section 4, on the other hand, is further encrypted using the receiver's public key to produce a data section 6 that has been both signed and encrypted. These operations enable both the authenticity of the sender and the contents of the data section to be verified by the receiver of the message. In conformity with the short message standard of the GSM system, the total length of the transmitted message is 140 bytes, i.e. 160 characters.

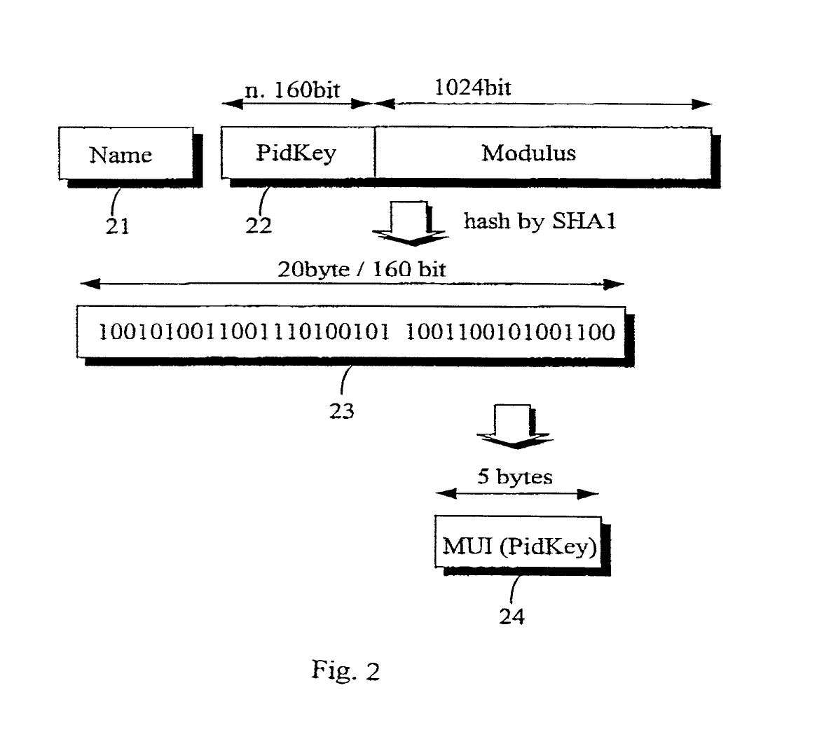

Depicted in FIG. 2 is the method by which the MUI (Pidkey) identifier that is included in the header section of the message of FIG. 1 is generated. With reference to block 21, the identification part to be generated is associated with a given name. A hash code is then generated using a hash function and the combination of the given name, the sender's public signing key (having a length of approximately 160 bits) and a 1024-bit modulus (block 22). The hash function may be, for example, be selected from among known functions such as SHA1 (Secure Hashing Algorithm 1) and MD5. The hashing procedure yields a 20-byte field (block 23). The MUI (Pidkey) identifier is then formed (block 24) by taking the last five bytes of the hashed identifier.

While there have shown and described and pointed out fundamental novel features of the invention as applied to a preferred embodiment thereof, it will be understood that various omissions and substitutions and changes in the form and details of the methods described and devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for transmitting in encrypted form, from a sender to a receiver, an initially unencrypted message so as to enable, through encryption, verification of authenticity of the sender and of integrity of contents of the message, comprising the steps of:
dividing the unencrypted message to be transmitted into a data section containing the contents of the unencrypted message and a header section;
generating a check element from the contents of the message to be transmitted;
appending the generated check element to the end of the data section;
adding sender identification data to the header section; and
at least one of encrypting and signing of the data section using an encryption method to enable reliable identification of the sender and the receiver of the encrypted message.

2. A method in accordance with claim 1, wherein the check element is generated using a hash function.

3. A method in accordance with claim 1, wherein the encryption method for said at least one of encrypting and signing of the data section comprises a public-private key encryption method.

4. A method in accordance with claim 1, wherein the encryption method for said at least one of encrypting and signing of the data section comprises use of the RSA encryption algorithm.

5. A method in accordance with claim 1, further comprising the step of adding to the header section an identifier of the encryption method used for said at least one of encrypting and signing of the data section.

6. A method in accordance with claim 1, wherein the sender identification data added to the header section comprises identification of an owner of a public key to be used to decrypt and verify a signature of the encrypted message.

7. A method in accordance with claim 1, wherein said step of at least one of encrypting and signing of the data section comprises signing of the data section with a digital signature.

8. A method in accordance with claim 1, wherein said step of at least one of encrypting and signing of the data section comprises signing of the data section using a private key of the sender and the encryption method comprises a public-private key encryption method.

9. A method in accordance with claim 8, wherein said step of at least one of encrypting and signing of the data section further comprises encrypting the signed data section using a public key of the receiver.

10. A method in accordance with claim 9, further comprising the step of decrypting the transmitted encrypted message using a private key of the receiver.

11. A method in accordance with claim 10, further comprising the step of identifying the sender of the transmitted encrypted message by decrypting, after said decrypting of the transmitted encrypted message using the private key of the receiver, the transmitted encrypted message using a public key of the sender.

12. A method in accordance with claim 8, further comprising the step of identifying the sender of the transmitted encrypted message by decrypting the transmitted encrypted message using a public key of the sender.

13. A method in accordance with claim 1, wherein the integrity of the transmitted encrypted message is verified using the check element appended to the data section.

14. A method in accordance with claim 1, further comprising the step of requesting, if errors are detected in the contents of the transmitted encrypted message, retransmission of the encrypted message.

15. A method in accordance with claim 1, further comprising the step of transmitting an acknowledgement of successful transmission of the encrypted message.

16. A method in accordance with claim 1, further comprising the step of transmitting the encrypted message through a mobile communication system.

17. A method in accordance with claim 16, where the mobile communication system comprises a GSM system.

18. A method in accordance with claim 16, wherein said step of at least one of encrypting and signing of the data section being carried out using a mobile station.
